(19) United States
(12) Patent Application Publication
(10) Pub. No.: US 2021/0323803 A1
(43) Pub. Date: Oct. 21, 2021

(54) MULTI-FUNCTIONAL ACCESSORY FOR A CYLINDRICAL STRUCTURE

(71) Applicant: Yabru LLC, Delafield, WI (US)

(72) Inventors: David Richard BAUER, Delafield, WI (US); Evan David BAUER, Memphis, TN (US)

(21) Appl. No.: 17/129,781

(22) Filed: Dec. 21, 2020

Related U.S. Application Data
(60) Provisional application No. 62/952,236, filed on Dec. 21, 2019.

(51) Int. Cl. B67B 7/16

(52) U.S. Cl. CPC B67B 7/16

(57) ABSTRACT

A system for providing one or more user accessories adjacent a cylindrical structure includes an accessory body constructed for mounting adjacent the outer surface of a cylindrical structure, and for providing at least one accessory feature to a user The body may be constructed to be mounted partially circumferentially, or circumferentially, about the longitudinal axis of the cylindrical structure. The body is constructed with an outer lip that functions as a bottle-opener accessory feature.

### CROSS-REFERENCE TO RELATED APPLICATION

This application claims priority to U.S Provisional Patent Application Ser. No. 62/952,236, filed Dec. 21, 2019, the disclosure of which is herein incorporated by reference.

### FIELD OF THE INVENTION

The invention relates to multi-functional accessories that include bottle openers. More specifically, the invention relates to a bottle openers that can be mounted adjacent a cylindrical structure such as a pole.

### BACKGROUND

Bottle openers are used in a variety of capacities and configurations. User mounted stationary openers are typically fastened to a flat object or surface. The opener has a single opening where a bottle is inserted into the void, the edge of the cap catches on a protruding lip and when the bottle is rotated downward the cap is removed. This is a unidirectional or singular operation allowing only one individual the opportunity to open a bottle at a time. Other stationary openers can be manufactured as a part of a product, such as; can openers, coolers, appliances, etc. Non-stationary or portable bottle openers are typically a handheld or keychain type opener. The portable openers are similar to the stationary openers as they are single user openers.

In many cases there may not be an appropriate surface to mount a stationary opener. In the case of a smaller diameter pole such as a patio umbrella the radius of the mounting surface is not conducive to support a traditional stationary opener. In addition, the material strength may also be inadequate to support the loads if a traditional stationary opener is mounted to such a pole or structure.

### BRIEF DESCRIPTION OF THE DRAWINGS

FIG. 1 shows the center structure of the plastic opener.

FIG. 2 shows the structure of the metal or plastic core opener and also shows an elastomeric inert (possible PU insert) to compensate for varying pole sizes.

FIG. 3 shows the opener body circumferentially coupled to the outer surface of the pole.

FIG. 4 shows the relationship between the edge of the bottle cap and the inner lip and the distance for the bottle cap to move within the opener.

FIG. 5 shows a donut-shaped space defined by the 360° movement of the opener about the longitudinal axis of the pole.

FIG. 6 shows a plastic core opener with a pair of metal contacts designed into the opener.

FIG. 7-8 shows interchangeable or stackable covers of the invention.

FIG. 9-10 shows the opener can also be modular when used with interchangeable or stackable covers.

FIG. 11 shows a version of the invention with a tapered surface formed on inner and outer portions of the plastic opener.

### SUMMARY OF THE INVENTION

The invention includes a system for providing one or more user accessories that includes an accessory body constructed for mounting adjacent the outer surface of a cylindrical structure, and for providing at least one accessory feature to a user. One accessory feature could be a bottle opener. Other features are described below in the Detailed Description. The body is constructed to be mounted circumferentially about that outer surface, but could also be mounted only partially circumferentially. For example, the body may be mounted so that it covers 90°, 180°, 270°, or 360°. The body may also include an outer lip that downwardly extends from the body, with the lip including an inner surface that is constructed to function as a bottle opener. One version of the outer lip could be that its inner surface is ribbed or otherwise contoured to provide a surface that will open a bottle when it is placed against that ribbed surface and a user applies sufficient pressure against that surface while holding and moving a bottle.

### DETAILED DESCRIPTION

The following specification describes one version of the multi-functional accessory of the present invention, wherein the body is constructed to function as a bottle opener. That version is also referred to as the invention below.

The invention provides an easy and convenient way to add an opener to a pole or cylindrical structure without fastening into the pole or structure. The invention allows a user to mount the bottle opener to the pole or cylindrical structure by surrounding the pole with the opener. A possible function within the overall invention of the pole-mounted opener is to make it accessible from 360°. The opener can either be loose or tightly clamped depending on users preference. By encompassing the pole or structure, the opener bears most of the load when a bottle is opened.

The opener can have a plastic or metal core/structure. The plastic or metal core/structure can also be configured as a stand-alone opener as well as having covers.

The covers can have various configurations and be interchangeable. The covers could be solely to provide a desired function, a desired look, or a hybrid that provide a desired function(s) and look. The functional features that may be incorporated in the covers Include: battery power supply, LED lights, speaker, Bluetooth module, photovoltaic cell, insect repellent, etc.

The opener can be cylindrical or conical in shape to allow a bottle to be opened at any point along the arc of the inner lip of the opener. Therefore, users can open a bottle at unlimited points around the inner circumference of the opener. The opener can also be configured as a non-cylindrical shape with multiple sides, such as hexagonal, rectangular, triangular, etc., or a single opener. This may reduce the number of individuals using the opener at the same time.

When the opener is fixed to a cylindrical structure, it also allows for users to open a bottle at multiple angles as well as the ability for multiple users at one time, such as a group of people seated around a patio table with the opener fixed to the pole. This allows for versatility and functionality without needing to pass around a mobile opener.

The fixed opener also ensures that the product will remain in place and can be used long term without misplacing traditional openers. In public settings this allows the user to open their own bottle without the need of a personal opener.

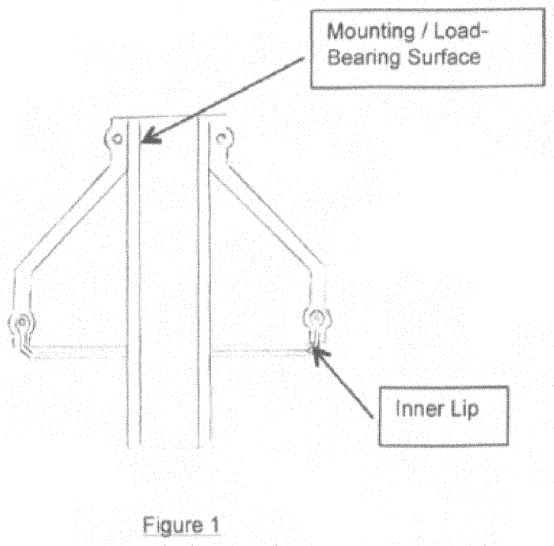

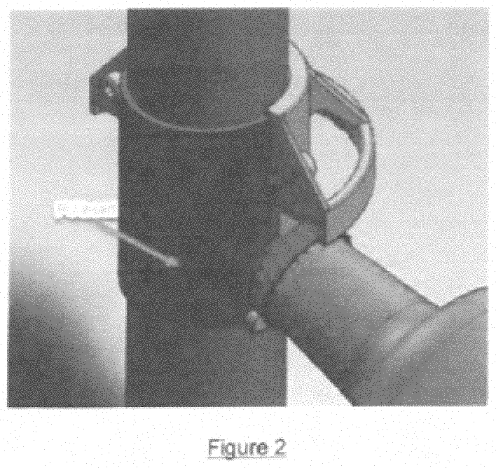

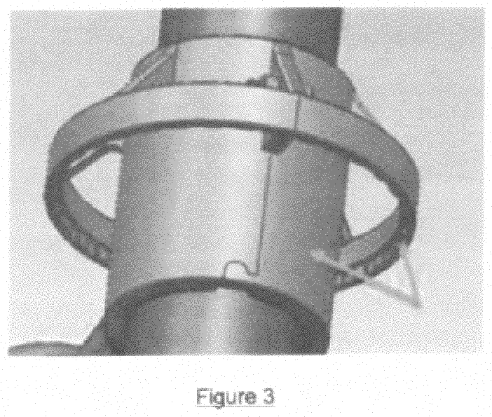

Referring to FIG. 1, the center portion, or structure, of the opener is the mounting/load-bearing surface that contacts the pole, and may be formed of plastic. FIG. 2 shows the structure of the metal or plastic core opener and also shows an elastomeric insert (possible PU insert) to compensate for varying pole sizes. The insert may have different thicknesses to compensate for varying pole sizes. Referring to FIG. 3, when mounting the opener to a pole or cylindrical structure the two halves of the opener are joined together by interlocking features, fasteners or straps. Once the halves of the opener are fastened together it forms a secure solid assembly mounted to the pole or cylindrical structure.

FIG. 1 shows a metal inner lip on the underside of the plastic opener body is contoured such that the lip catches the edge of the bottle cap. The metal lip is an integral part of the opener to ensure optimum function.

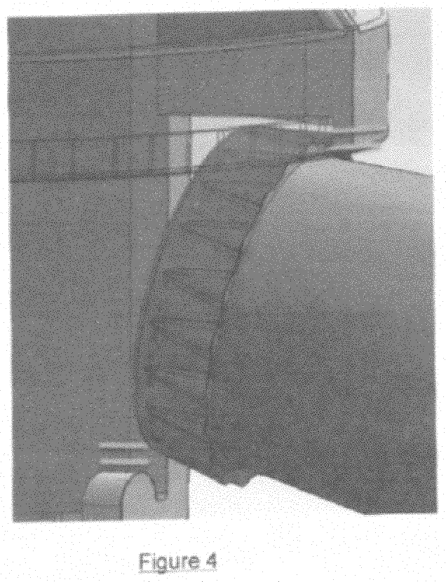

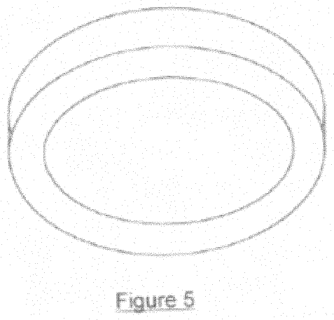

In a version wherein the opener body is circumferentially mounted adjacent the pole, the invention allows the user to access the opener from 360° about the longitudinal axis of the pole. In other words, the user could open a bottle using the invention from any point about the pole. As long as the edge of bottle cap catches the inner lip, the user can open the bottle without an issue. FIG. 3 shows the opener with 360° accessibility in X-Y plane. FIG. 4 shows the relationship between the edge of the bottle cap and the inner lip and the distance for the bottle cap to move within the opener. Referring to FIG. 5, the 360° of accessibility in the X-Y plane and the distance allowable for the bottle cap to move in Z-axis forms a 3-dimensional donut-shaped space. As long as the bottle cap is inserted into this 3-dimensional space, the bottle can be opened.

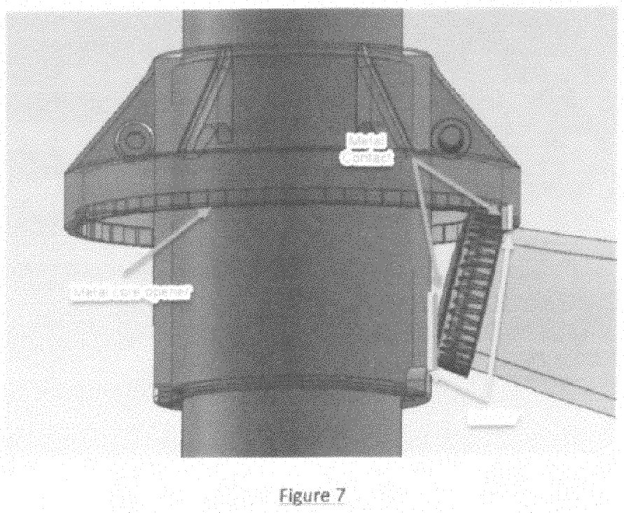

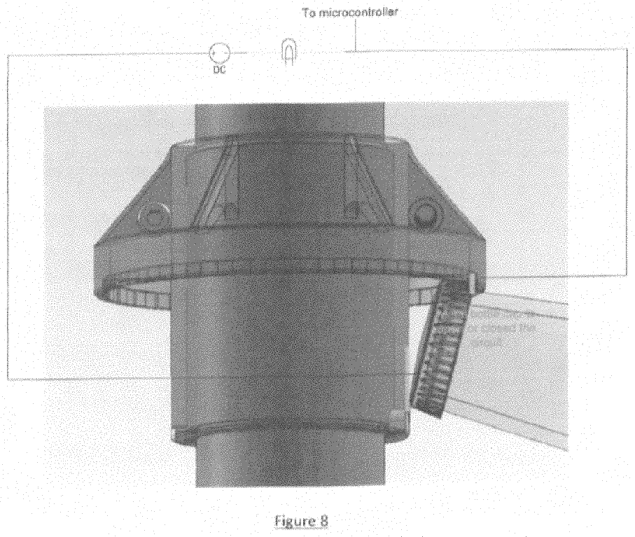

Referring to FIGS. 7-8, the features of the interchangeable or stackable covers can also include: LED lighting, speakers (including BT speakers), bottle cap holder including magnetic type holder, stationary or removable charging station, solar panel(s), bug repellant, etc.

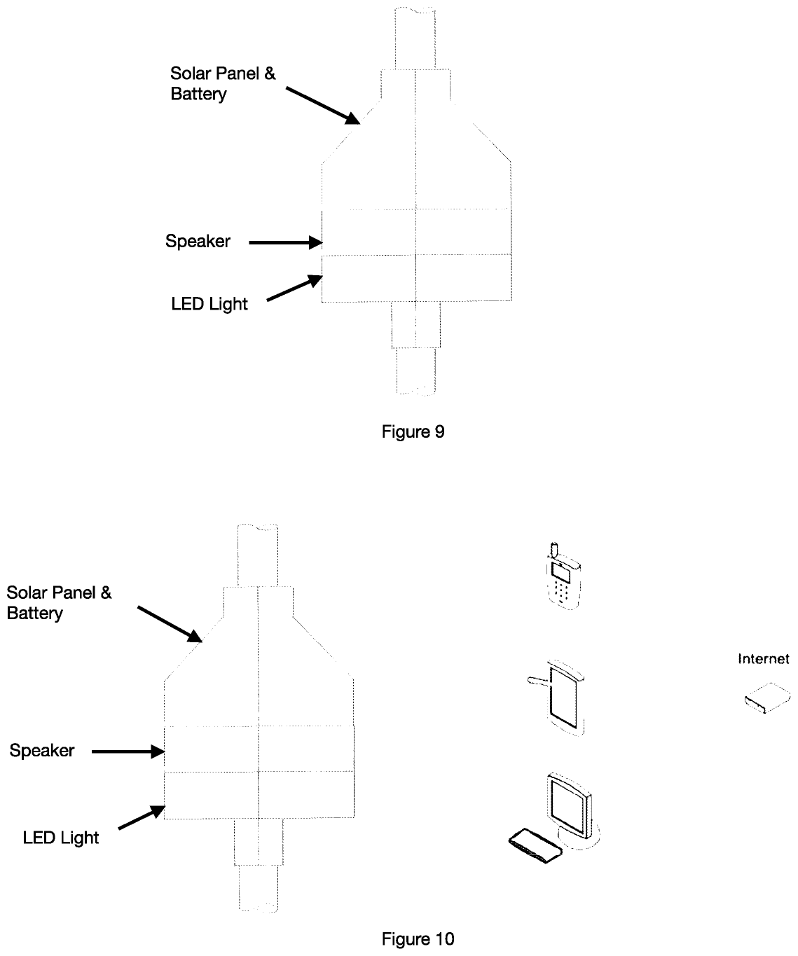

Referring to FIGS. 9-10, the opener can also be modular when used with interchangeable or stackable covers. Like covers in general, the interchangeable or stackable cover feature can be solely functional, for look, or a hybrid that provides desired function(s) and a desired look.

Another option for the opener is to have the opener lip and cap contact point isolated from each other so when the bottle cap is inserted into the opener and the bottle is opened, the bottle cap can complete an electrical circuit to trigger an LED light, music or other features offered with the opener.

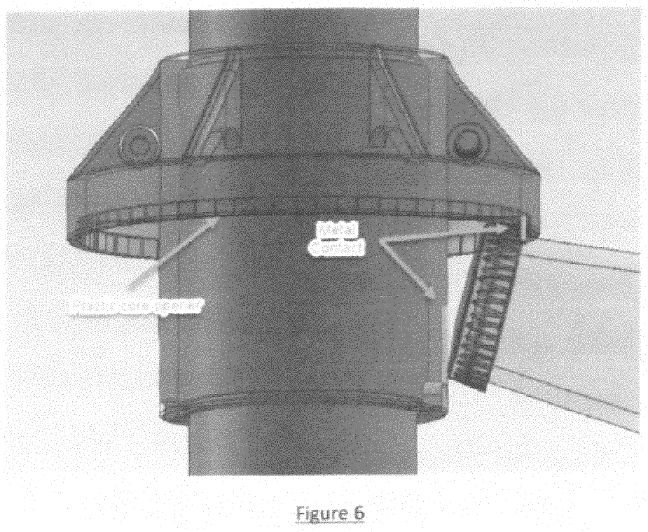

FIG. 6 shows a plastic core opener with a pair of metal contacts designed into the opener. If the opener is metal, then an isolator will be added between the opener core and the metal contact. FIG. 7 shows a metal core with an insulator and a pair of metal contacts.

FIG. 9 shows that the interchangeable covers can be stackable and interconnected to share the common power source and share common wired communication lines.

Referring to FIGS. 8 and 10, the interchangeable and stackable covers can also be constructed to communicate with each other via wireless communication. The wireless connected interchangeable and stackable covers can also communication to a computer, a smart phone or a tablet or any mobile devices with wireless capability then can be connected to the Internet. The wireless connected covers can then be controlled or monitored via local computer or mobile devices or be controlled or monitored remotely via the Internet. The wireless protocol includes WiFi, Bluetooth, Zigbee and other wireless communications.

Pole or cylindrical structure diameters vary. There are a number of options to address the size differences when mounting the opener to the pole or structure. Referring to FIG. 2, Option 1 is to use an elastomeric insert; this can be implemented in both metal and plastic opener structures. Option 2 is to use interchangeable spacers to account for the diameter differences; this can be implemented in both metal and plastic opener structures (not shown). Option 3 is to utilize an elliptical or oval shaped center bearing structure the contacts the pole (not shown).

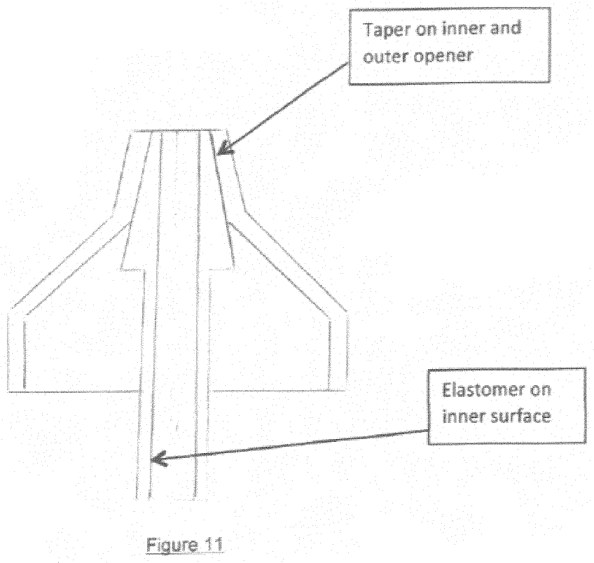

Referring to FIG. 11, Option 4 is to incorporate a taper on the inner and outer portions of the plastic opener. When the opener is mounted to the pole and the inner and outer portions of the opener are driven axially in opposite directions, the inner diameter of the inner members will increase or decrease in size depending on axial location of the sliding member. The inner member may also be slightly oval or elliptical to allow the sliding member to conform better to different pole diameters. In addition, an elastomer may be added to the inner mounting surface to improve further the coupling, or conformity of the opener to the pole.

What is claimed:

1. A system for providing one or more user accessories adjacent a cylindrical structure, comprising:
an accessory body constructed for mounting adjacent the outer surface of a cylindrical structure, and for providing at least one accessory feature to a user.

2. The system of claim 1, wherein body is constructed to be mounted partially circumferentially about the longitudinal axis of the cylindrical structure.

3. The system of claim 2, wherein the body is constructed to be mounted circumferentially about the longitudinal axis of the cylindrical structure.

4. The system of claim 1, wherein the body is constructed with an outer lip that a bottle-opener accessory feature.
